(19) United States
(12) Patent Application Publication
(10) Pub. No.: US 2025/0083994 A1
(43) Pub. Date: Mar. 13, 2025

(54) GLASSES AND CERAMICS WITH SELF-DISPERSED CORE-SHELL NANOSTRUCTURES VIA CASTING

(71) Applicant: The Regents of the University of California, Oakland, CA (US)

(72) Inventor: Xiaochun LI, Los Angeles, CA (US)

(73) Assignee: The Regents of the University of California, Oakland, CA (US)

(21) Appl. No.: 18/291,863

(22) PCT Filed: Jul. 27, 2022
(86) PCT No.: PCT/US2022/038584

§ 371 Date: Jan. 24, 2024

Related U.S. Application Data
(60) Provisional application No. 63/226,613, filed on Jul. 28, 2021.

(51) Int. Cl. C03C 14/00; C04B 35/626; C04B 35/653; C04B 35/80

(52) U.S. Cl. CPC C03C 14/002; C03C 14/004; C04B 35/62625; C04B 35/62655; C04B 35/653; C04B 35/80; C03C 2214/03; C03C 2214/05; C03C 2214/30; C04B 2235/422; C04B 2235/5248

(57) ABSTRACT

Nanocomposite ceramic or glass materials are disclosed herein, which include a matrix material and one or more nanostructures dispersed within the matrix material. The nanostructures may comprise one or more core-shell nanostructures including a core nanostructure and a shell material. The shell material may be different from the material making up the core nanostructure and may improve the wettability of the core-shell nanostructure, the dispersion of the core-shell nanostructure within the matrix material, or make the core-shell nanostructure more resistant to oxidation, when compared to the core nanostructure alone. Methods of making nanocomposite ceramic or glass materials are also disclosed herein.

### CROSS-REFERENCE TO RELATED PATENT APPLICATIONS

This application claims priority to U.S. Provisional Patent Application No. 63/226,613, filed Jul. 28, 2021, the contents of which is hereby incorporated by reference in its entirety.

### BACKGROUND

Glasses and ceramics are important materials in nature and have significant societal value for their applications in daily life and industry, such as fine china, dental implants, electronics, chemicals, and manufacturing. This is due to their advantageous and desirable properties, including low density, high hardness, and chemical stability. However, ceramics are brittle because of their covalent and/or ionic bonds, and they often fail under about 1% to about 2% elastic strain. This has created a long-standing challenge for their processing and application as reliable product materials.

Ceramic matrix nanocomposites have been developed which include a high volume fraction of uniformly dispersed nanostructures. In these materials, nanostructures can be self-dispersed in ceramic melts, and bulk ceramics containing high loadings of the nanostructures can be cast from these ceramic melts. Although these materials relied on incorporation of semiconductor, carbide, or nitride nanoparticles into glasses as a proof-of-concept, scaling up their production up to commercially viable amounts is challenging for several reasons, including: poor wettability of the semiconductor, carbide, nitride, or boride particles in the glass matrix; relatively poor dispersion; and difficulty in avoiding oxidation at the high processing temperatures required to disperse the nanoparticles in the matrix. Thus, methods for improving the wettability, dispersion, and oxidation resistance of the nanostructures are of great commercial interest.

It is against this background that a need arose to develop the embodiments described herein.

### SUMMARY

In one aspect, which may be combined with any other aspect or embodiment, the present disclosure relates to a nanocomposite ceramic or glass material, comprising: one or more matrix materials; and one or more nanostructures dispersed with the matrix material; wherein: the one or more nanostructures comprises a core-shell nanostructure.

In some embodiments, the core-shell nanostructure comprises a core material and a shell material coating the core nanostructure; and the shell material improves the wettability of the nanostructure by the matrix material and dispersion of the nanostructure within the matrix, relative to the core nanostructure alone.

In some embodiments, the shell material comprises the same material as the matrix material. In some embodiments, the core nanostructure comprises a carbon-based material.

In some embodiments, the nanostructure is present in the matrix material at a concentration (v/v) of at least about 1.0%. In some embodiments, the nanostructure is present in the matrix material at a concentration (v/v) of at least about 10%. In some embodiments, the nanostructure is present in the matrix material at a concentration (v/v) of at least about 20%.

In some embodiments, the nanocomposite ceramic or glass material has a fracture toughness of 2 MPa·m^{1/2} or greater. In some embodiments, the nanocomposite ceramic or glass material has a strain limit of about 2% or greater. In some embodiments, the nanocomposite ceramic or glass material has a strength of about E/50 or greater, wherein E is elastic modulus. In some embodiments, the nanocomposite ceramic or glass material has a strength of about E/20 or greater.

In another aspect, which may be combined with any other aspect of embodiment, the present disclosure relates to a method of forming a nanocomposite ceramic or glass material, comprising: (a) mixing: (i) raw matrix powder(s), (ii) nanostructure powder(s), fibers, platelets, or any combination thereof, and optionally (iii) one or more viscosity-reducing materials; (b) dispersing the matrix powder(s), nanostructure powder(s), fibers, platelets, or any combination thereof, and, optionally, the one or more viscosity-reducing materials in a solvent to form a nanostructure dispersion; (c) agitating the nanostructure dispersion to form a slurry; (d) drying the slurry to form a mixed powder; (e) melting the mixed powder; and (f) cooling the melted mixed powder to form the nanocomposite ceramic or glass material; wherein the nanostructure powder(s) comprises a core-shell nanostructure.

In some embodiments, the core-shell nanostructure comprises a core material and a shell material coating the core nanostructure; and the shell material improves the wettability of the nanostructure by the matrix material and/or dispersion of the nanostructure within the matrix, relative to the core nanostructure alone.

In some embodiments, the shell material comprises the same material as the matrix material. In some embodiments, the core nanostructure comprises a carbon-based material.

In some embodiments, in the nanocomposite ceramic or glass material, the nanostructure is present in the matrix material at a concentration (v/v) of at least about 1%. In some embodiments, the nanostructure is present in the matrix material at a concentration (v/v) of at least about 10%. In some embodiments, the nanostructure is present in the matrix material at a concentration (v/v) of at least about 20%.

In some embodiments, the nanocomposite ceramic or glass material has a fracture toughness of 2 MPa·m^{1/2} or greater. In some embodiments, the nanocomposite ceramic or glass material has a strain limit of about 2% or greater. In some embodiments, the nanocomposite ceramic or glass material has a strength of about E/50 or greater, wherein E is elastic modulus. In some embodiments, the nanocomposite ceramic or glass material has a strength of about E/20 or greater.

### DETAILED DESCRIPTION

In some embodiments, the present disclosure relates to ceramic matrix nanocomposites including a high volume fraction of uniformly dispersed nanostructures and to methods of manufacturing such nanocomposites. In some embodiments, a ceramic matrix nanocomposite comprises, consists essentially of, or consists of a matrix of one or more ceramics and reinforcing nanostructures dispersed in the matrix. In some embodiments, the reinforcing nanostructures comprise, consist essentially of, or consist of core-shell nanostructures.

### Matrix Materials

In some embodiments, the matrix material may comprise any combination of glasses and/or ceramic materials. In some embodiments, the matrix material is amorphous or includes an amorphous phase. In some embodiments, the matrix material may comprise one or more glasses (e.g., silica, silicate glasses, fused silica glasses aluminosilicate glasses, borosilicate glasses, soda-lime glasses, lead glasses, quartz, phosphate glasses, germinates, tellurites, atimonates, arsenates, titanates, tantalates, fluoride glasses, doped glasses, or any combination thereof, etc.). By way of non-limiting example, suitable matrix materials include metal oxides (e.g., alkaline earth metal oxides, post-transition metal oxides, rare earth metal oxides, and transition metal oxides, such as aluminum oxide (Al₂O₃), magnesium oxide (MgO), titanium oxide (TiO₂), and zirconium oxide (ZrO₂)), non-metal oxides (e.g., metalloid oxides such as silicon oxide (SiO₂) and boron oxide (B₂O₃)), metal carbides (e.g., transition metal carbides, such as titanium carbide (TiC), niobium carbide (NbC), chromium carbide (Cr₃C₂), nickel carbide (NiC), hafnium carbide (HfC), vanadium carbide (VC), tungsten carbide (WC), and zirconium carbide (ZrC)), non-metal carbides (e.g., metalloid carbides such as silicon carbide (SiC)), metal silicides (e.g., transition metal silicides, such as titanium silicide (TiSi)), metal borides (e.g., transition metal borides, such as titanium boride (TiB₂), zirconium boride (ZrB₂), hafnium boride (HfB₂), vanadium boride (VB₂), and tungsten boride (W₂B₅)), metal nitrides (e.g., transition metal nitrides), non-metal nitrides (e.g., metalloid nitrides such as silicon nitride), alloys, mixtures, or other combinations of two or more of the foregoing.

### Nanostructure Materials

In some embodiments, nanostructures may have at least one dimension in a range of about 1 nm to about 1000 nm, such as about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 70 nm, about 1 nm to about 60 nm, about 1 nm to about 50 nm, about 1 nm to about 40 nm, about 1 nm to about 30 nm, about 1 nm to about 20 nm, about 1 nm to about 10 nm, about 1 nm to about 5 nm, or any range or value therein between. Of course, other ranges are contemplated, and the endpoints of any of the above ranges may be combined (e.g., about 25 nm to about 50 nm, about 300 nm to about 500 nm, about 100 nm to about 500 nm, and so forth).

In some embodiments, the nanostructures may have at least one average or median dimension (e.g., diameter, length, width, thickness, etc.) in a range of about 1 nm to about 1000 nm, such as about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 70 nm, about 1 nm to about 60 nm, about 1 nm to about 50 nm, about 1 nm to about 40 nm, about 1 nm to about 30 nm, about 1 nm to about 20 nm, about 1 nm to about 10 nm, about 1 nm to about 5 nm, or any range or value therein between. Of course, other ranges are contemplated, and the endpoints of any of the above ranges may be combined (e.g., about 25 nm to about 50 nm, about 300 nm to about 500 nm, about 100 nm to about 500 nm, and so forth).

In some embodiments, the nanostructures may comprise, consist essentially of, or consist of nanoparticles having an aspect ratio of about 1000 or less, about 900 or less, about 800 or less, about 700 or less, about 600 or less, about 500 or less, about 400 or less, about 300 or less, about 250 or less, about 200 or less, about 150 or less, about 100 or less, about 90 or less, about 80 or less, about 70 or less, about 60 or less, about 50 or less, about 40 or less about 30 or less, about 25 or less, about 20 or less, about 15 or less, about 10 or less, about 9 or less, about 8 or less, about 7 or less, about 6 or less, about 5 or less, about 4 or less, about 3 or less, about 2.5 or less, about 2 or less, about 1.5 or less, about 1.2 or less, or any range or value therein between.

In some embodiments, the nanostructures may have generally spherical or spheroidal shapes, although other shapes and configurations of nanostructures are contemplated (e.g., nanotubes, nanorods, nanocubes, nanoprisms, nanofibers, and nanoplatelets, or any combination thereof). In the case of nanoparticles of some embodiments, the nanoparticles can have at least one dimension (e.g., an effective diameter which is twice an effective radius) or at least one average or median dimension (e.g., an average effective diameter which is twice an average effective radius) in a range of in a range of about 1 nm to about 1000 nm, such as about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 70 nm, about 1 nm to about 60 nm, about 1 nm to about 50 nm, about 1 nm to about 40 nm, about 1 nm to about 30 nm, about 1 nm to about 20 nm, about 1 nm to about 10 nm, about 1 nm to about 5 nm, or any range or value therein between. Of course, other ranges are contemplated, and the endpoints of any of the above ranges may be combined (e.g., about 25 nm to about 50 nm, about 300 nm to about 500 nm, about 100 nm to about 500 nm, and so forth).

In some embodiments, nanostructures may include one or more ceramics, although other nanostructure materials are contemplated. Examples of suitable nanostructure materials include metal oxides (e.g., alkaline earth metal oxides, post-transition metal oxides, and transition metal oxides, such as aluminum oxide (Al₂O₃), magnesium oxide (MgO), titanium oxide (TiO₂), and zirconium oxide (ZrO₂)), non-metal oxides (e.g., metalloid oxides such as silicon oxide (SiO₂)), metal carbides (e.g., transition metal carbides, such as titanium carbide (TiC), niobium carbide (NbC), chromium carbide (Cr₃C₂), nickel carbide (NiC), hafnium carbide (HfC), vanadium carbide (VC), tungsten carbide (WC), and zirconium carbide (ZrC)), non-metal carbides (e.g., metalloid carbides such as silicon carbide (SiC)), metal silicides (e.g., transition metal silicides, such as titanium silicide (TiSi)), metal borides (e.g., transition metal borides, such as titanium boride (TiB₂), zirconium boride (ZrB₂), hafnium boride (HfB₂), vanadium boride (VB₂), and tungsten boride (W₂B₅)), metal nitrides (e.g., transition metal nitrides), non-metal nitrides (e.g., metalloid nitrides such as silicon nitride), alloys, mixtures, or other combinations of two or more of the foregoing. Particular examples of suitable nanostructure materials include non-metal-containing ceramics, such as metalloid carbides and other metalloid-containing ceramics.

In some embodiments, nanostructures may include one or more carbon-based materials. By way of non-limiting example, suitable carbon-based materials may include carbon nanotubes, graphene, graphene oxide, graphite, diamond, amorphous carbon, fullerenes or any combination thereof.

### Core-Shell Nanostructures

In some embodiments, the nanostructures may comprise core-shell nanostructures in which a core nanostructure (which may comprise any combination of the materials, in the sizes and/or shapes discussed above, at any of the dimensions discussed above) is coated with a shell of a second material (e.g., a shell material). In some embodiments, the shell may comprise any suitable material. For example, the shell material may comprise metal oxides (e.g., alkaline earth metal oxides, post-transition metal oxides, and transition metal oxides, such as aluminum oxide (Al₂O₃), magnesium oxide (MgO), titanium oxide (TiO₂), and zirconium oxide (ZrO₂)), non-metal oxides (e.g., metalloid oxides such as silicon oxide (SiO₂)), metal carbides (e.g., transition metal carbides, such as titanium carbide (TiC), niobium carbide (NbC), chromium carbide (Cr₃C₂), nickel carbide (NiC), hafnium carbide (HfC), vanadium carbide (VC), tungsten carbide (WC), and zirconium carbide (ZrC)), non-metal carbides (e.g., metalloid carbides such as silicon carbide (SiC)), metal silicides (e.g., transition metal silicides, such as titanium silicide (TiSi)), metal borides (e.g., transition metal borides, such as titanium boride (TiB₂), zirconium boride (ZrB₂), hafnium boride (HfB₂), vanadium boride (VB₂), and tungsten boride (W₂B₅)), metal nitrides (e.g., transition metal nitrides), non-metal nitrides (e.g., metalloid nitrides such as silicon nitride), alloys, mixtures, or other combinations of two or more of the foregoing. In some embodiments, the shell may comprise an oxidized form of the material making up the core (e.g., graphene oxide on graphene). In some embodiments, the shell may comprise the same material(s) making up the matrix.

In some embodiments, the shell may be amorphous or comprise an amorphous phase. By way of non-limiting example, suitable shell materials include metal oxides (e.g., alkaline earth metal oxides, post-transition metal oxides, rare earth metal oxides, and transition metal oxides, such as aluminum oxide (Al₂O₃), magnesium oxide (MgO), titanium oxide (TiO₂), and zirconium oxide (ZrO₂)), non-metal oxides (e.g., metalloid oxides such as silicon oxide (SiO₂) and boron oxide (B₂O₃)), metal carbides (e.g., transition metal carbides, such as titanium carbide (TiC), niobium carbide (NbC), chromium carbide (Cr₃C₂), nickel carbide (NiC), hafnium carbide (HfC), vanadium carbide (VC), tungsten carbide (WC), and zirconium carbide (ZrC)), non-metal carbides (e.g., metalloid carbides such as silicon carbide (SiC)), metal silicides (e.g., transition metal silicides, such as titanium silicide (TiSi)), metal borides (e.g., transition metal borides, such as titanium boride (TiB₂), zirconium boride (ZrB₂), hafnium boride (HfB₂), vanadium boride (VB₂), and tungsten boride (W₂B₅)), metal nitrides (e.g., transition metal nitrides), non-metal nitrides (e.g., metalloid nitrides such as silicon nitride), alloys, mixtures, or other combinations of two or more of the foregoing.

In some embodiments, the shell material may include one or more carbon-based materials. By way of non-limiting example, suitable carbon-based materials may include carbon nanotubes, graphene, graphene oxide, graphite, diamond, amorphous carbon, fullerenes, or any combination thereof.

In some embodiments, the shell may have an average thickness of more than one monolayer. In some embodiments, the shell may have an average thickness of less than one monolayer (e.g., a partial monolayer). In some embodiments, the shell may have an average thickness of greater than or equal to about 0.1 monolayers, greater than or equal to about 0.2 monolayers, greater than or equal to about 0.3 monolayers, greater than or equal to about 0.4 monolayers, greater than or equal to about 0.5 monolayers, greater than or equal to about 0.6 monolayers, greater than or equal to about 0.7 monolayers, greater than or equal to about 0.8 monolayers, greater than or equal to about 0.9 monolayers, greater than or equal to about 1 monolayers, greater than or equal to about 1.2 monolayers, greater than or equal to about 1.5 monolayers, greater than or equal to about 1.8 monolayers, greater than or equal to about 2 monolayers, greater than or equal to about 2.5 monolayers, greater than or equal to about 3 monolayers, greater than or equal to about 3.5 monolayers, greater than or equal to about 4 monolayers, greater than or equal to about 4.5 monolayers, greater than or equal to about 5 monolayers, greater than or equal to about 6 monolayers, greater than or equal to about 7 monolayers, greater than or equal to about 8 monolayers, greater than or equal to about 9 monolayers, greater than or equal to about 10 monolayers, greater than or equal to about 11 monolayers, greater than or equal to about 12 monolayers, greater than or equal to about 13 monolayers, greater than or equal to about 14 monolayers, greater than or equal to about 15 monolayers, greater than or equal to about 20 monolayers, greater than or equal to about 25 monolayers, greater than or equal to about 30 monolayers, greater than or equal to about 35 monolayers, greater than or equal to about 40 monolayers, greater than or equal to about 45 monolayers, greater than or equal to about 50 monolayers, greater than or equal to about 60 monolayers, greater than or equal to about 70 monolayers, greater than or equal to about 80 monolayers, greater than or equal to about 90 monolayers, greater than or equal to about 100 monolayers, or more, or any range or value therein between.

In some embodiments, the shell may have an average thickness of greater than or equal to about 0.2 nm, greater than or equal to about 0.4 nm, greater than or equal to 0.5 nm, greater than or equal to about 0.6 nm, greater than or equal to about 0.8 nm, greater than or equal to about 1 nm, greater than or equal to about 1.2 nm, greater than or equal to about 1.4 nm, greater than or equal to about 1.5 nm, greater than or equal to about 1.6 nm, greater than or equal to about 1.8 nm, greater than or equal to about 2 nm, greater than or equal to about 2.5 nm, greater than or equal to about 3 nm, greater than or equal to about 3.5 nm, greater than or equal to about 4 nm, greater than or equal to about 4.5 nm, greater than or equal to about 5 nm, greater than or equal to about 6 nm, greater than or equal to about 7 nm, greater than or equal to about 8 nm, greater than or equal to about 9 nm, greater than or equal to about 10 nm, greater than or equal to about 15 nm, greater than or equal to about 20 nm, greater than or equal to about 25 nm, greater than or equal to about 30 nm, greater than or equal to about 35 nm, greater than or equal to about 40 nm, greater than or equal to about 45 nm, greater than or equal to about 50 nm, greater than or equal to about 60 nm, greater than or equal to about 70 nm, greater than or equal to about 80 nm, greater than or equal to about 90 nm, greater than or equal to about 100 nm, greater than or equal to about 150 nm, greater than or equal to about 200 nm, greater than or equal to about 250 nm, greater than or equal to about 300 nm, greater than or equal to about 350 nm, greater than or equal to about 400 nm, greater than or equal to about 450 nm, or greater than or equal to about 500 nm, or more, or any range or value therein between.

In some embodiments, the shell may cover the entire core or only partially cover the core. In some embodiments, the shell may cover the core at a ratio (by area) of greater than or equal to about 0.1%, greater than or equal to about 0.2%, greater than or equal to about 0.3%, greater than or equal to about 0.4%, greater than or equal to about 0.5%, greater than or equal to about 0.6%, greater than or equal to about 0.7%, greater than or equal to about 0.8%, greater than or equal to about 0.9%, greater than or equal to about 1%, greater than or equal to about 1.5%, greater than or equal to about 2%, greater than or equal to about 2.5%, greater than or equal to about 3%, greater than or equal to about 3.5%, greater than or equal to about 4%, greater than or equal to about 4.5%, greater than or equal to about 5%, greater than or equal to about 5.5%, greater than or equal to about 6%, greater than or equal to about 6.5%, greater than or equal to about 7%, greater than or equal to about 7.5%, greater than or equal to about 8%, greater than or equal to about 8.5%, greater than or equal to about 9%, greater than or equal to about 9.5%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 55%, greater than or equal to about 60%, greater than or equal to about 65%, greater than or equal to about 70%, greater than or equal to about 75%, greater than or equal to about 80%, greater than or equal to about 85%, greater than or equal to about 90%, greater than or equal to about 95%, greater than or equal to about 96%, greater than or equal to about 97%, greater than or equal to about 98%, greater than or equal to about 99%, or about 100%, or any range or value therein between.

In some embodiments, the shell material may be formed on the core by any suitable method, including oxidative methods, physical vapor deposition, electrochemical deposition, chemical vapor deposition, or any other method suitable or forming the shell material on the core. In some embodiments, the oxidative methods may include thermal oxidation in an oxygen-containing atmosphere, oxidation in an ozone-containing atmosphere (e.g., in UV-irradiated oxygen-containing gaseous environment), chemical oxidation (e.g., using strong acids and/or oxidants, such as hydrogen peroxide), plasma treatment, or any other suitable method. In some embodiments, the shell may be deposited onto the core by physical vapor deposition (e.g., sputtering). In some embodiments, the shell may be deposited onto the core by atomic layer deposition (ALD) or molecular layer deposition (MLD). In some embodiments, the shell may be formed on the core by wet chemical methods (e.g., sol-gel).

### Nanocomposite Formation and Properties

In some embodiments, the inclusion of nanostructures into the matrix material may enhance the mechanical, thermal, electronic, and/or optical properties of the matrix material. For example SiC, carbon-based, or carbon-like materials may enhance the thermal properties of ceramic and/or glass matrix materials. By way of a further non-limiting example, certain borides (e.g., TiB₂) may enhance the electrical properties of ceramic and/or glass matrix materials. By way of further non-limiting example, metal nanowires (e.g., Au, Ag, Pt, Pd, Cu, etc.) may enhance thermal and electronic properties of glass and/or ceramic matrix materials. Those of ordinary skill in the art will recognize that there are other combinations of nanostructures and matrix materials to enhance one or more properties of the matrix materials.

In some embodiments, the nanostructures may have improved wettability in the matrix material and may be more readily dispersed into the matrix material. Suitable nanostructures can be selected for self-dispersion in a ceramic matrix for processing at a temperature T, which can be set to about (Tₘₑₗₜ+200 K), with Tₘₑₗₜ being a melting temperature of a matrix material, although other processing temperatures in a range greater than about Tₘₑₗₜ and up to about (Tₘₑₗₜ+250 K) are contemplated. In some embodiments, selection of the nanostructures can satisfy the following conditions: (1) the nanostructures undergo little or no chemical reaction with a melt of the matrix; (2) good wettability of the nanostructures by the melt of the matrix, as characterized by, for example, a contact angle θ of the melt with a respect to a surface of a nanostructure material at the processing temperature T of less than about 90°, such as about 88° or less, about 85° or less, about 80° or less, about 75° or less, about 70° or less, about 60° or less, about 50° or less, about 40° or less, or about 30° or less; and

$$\vert {W}_{vdwmax} \vert < kT or {\text{\textbar} [ {( {A}_{n a n o s t r u c t u r e} )}^{1 / 2} - {( {A}_{matrix} )}^{1 / 2} ]}^{2} \times ( 1 / 12 ) \times ( R / {d}_{1} ) < k T ,$$

where A_{nanostructure} is the Hamaker constant of the nanostructure material, Aₘₐₜᵣᵢₓ is the Hamaker constant of the matrix material, R is an average effective radius of the nanostructures, d₁ can be set to be about 0.4 nm, and k is Boltzmann's constant.

In some embodiments, a ceramic matrix nanocomposite includes nanostructures at a high volume fraction of about 3% or greater, such as about 5% or greater, about 6% or greater, about 7% or greater, about 8% or greater, about 9% or greater, about 10% or greater, about 11% or greater, about 12% or greater, about 13% or greater, about 14% or greater, about 15% or greater, about 20% or greater, about 25% or greater, or about 30% or greater, or about 35% or greater, or about 40% or greater, or about 45% or greater, or about 50% or greater, or any range or value therein between

During manufacturing of a ceramic matrix nanocomposite, a powder mixture is formed by combining one or more ceramics (such in a powder or particulate form, for example in the form of microstructures) and reinforcing nanostructures, followed by mixing, such as by a mechanical shaker or other manner of agitation and then dispersion in a solvent under ultrasonic processing and evaporation of the solvent. The nanostructures can be introduced into the well-blended powder mixture at a relatively high volume fraction of about 3% or greater, such as about 5% or greater, about 6% or greater, about 7% or greater, about 8% or greater, about 9% or greater, about 10% or greater, about 11% or greater, about 12% or greater, about 13% or greater, about 14% or greater, about 15% or greater, about 20% or greater, about 25% or greater, or about 30% or greater, about 35% or greater, about 40% or greater, about 45% or greater, and up to about 50% or greater.

The well-blended powder mixture is then heated to a temperature at or above a melting temperature of the one or more ceramics to form a melt under a protection gas of argon (Ar) or another inert gas. Agitation by ultrasonic processing and, in particular, ultrasonic cavitation-assisted processing can be performed on the melt during heating to reduce porosity and promote uniform dispersion of the nanostructures. A resulting nanocomposite is obtained by cooling under a protection gas of Ar or another inert gas. The resulting nanocomposite can provide desirable mechanical properties for various applications. For example, the nanocomposite can have a fracture toughness of about 2 MPa·m^{1/2} or greater, about 3 MPa m^{1/2} or greater, about 4 MPa·m^{1/2} or greater, about 5 MPa·m^{1/2} or greater, or about 6 MPa·m^{1/2} or greater, and up to about 7 MPa·m^{1/2} or greater.

In some embodiments, the nanocomposite may have a strain limit of about 2% or greater, about 3% or greater, about 4% or greater, about 5% or greater, about 6% or greater, about 7% or greater, about 8% or greater, about 9% or greater, or about 10% or greater, and up to about 15% or greater. In some embodiments, the nanocomposite may have a strength of about E/50 or greater, about E/45 or greater, about E/40 or greater, about E/35 or greater, about E/30 or greater, about E/25 or greater, about E/23 or greater, about E/20 or greater, about E/18 or greater, about E/16 or greater, about E/15 or greater, about E/14 or greater, about E/13 or greater, about E/12 or greater, and up to about E/11 or greater, wherein E is elastic modulus.

In some embodiments, the present disclosure relates to a method of forming a nanocomposite ceramic material, comprising: (a) mixing: (i) raw matrix powder(s), (ii) nanostructure powder(s), and optionally (iii) one or more viscosity-reducing materials; (b) dispersing the matrix powder(s), nanostructure powder(s), and, optionally, the one or more viscosity-reducing materials in a solvent to form a nanostructure dispersion; (c) agitating the nanostructure dispersion to form a slurry; (d) drying the slurry to form a mixed powder; (e) melting the mixed powder; and (f) cooling the melted mixed powder to form the nanocomposite ceramic material.

In some embodiments, the nanostructures may be dispersed in the matrix material by a method comprising: (a) mixing raw matrix powder(s) and nanostructure powder(s)/fibers/platelets, such that the relative masses of matrix powder(s) and nanostructure powder(s) correspond to a volume percentage of nanostructures in the matrix material; (b) optionally adding one or more viscosity-reducing materials (e.g., B₂O₃); (c) stirring the matrix powder(s), nanostructure powder(s), and the one or more viscosity-reducing materials; (d) dispersing the matrix powder(s), nanostructure powder(s), and the one or more viscosity-reducing materials in a solvent to form a nanostructure dispersion; (e) agitating the nanostructure dispersion to form a slurry; (f) drying the slurry to form a mixed powder; and (g) melting the mixed powder. Such methods are described, e.g., in Q.-G. Jiang, Strong and Tough Glass With Self-Dispersed Nanoparticles Via Solidification, 31 ADV. MATER. 1901803 (2019), the entirety of which is hereby incorporated by reference in its entirety.

As used herein, the singular terms “a,” “an,” and “the” may include plural referents unless the context clearly dictates otherwise. Thus, for example, reference to an object may include multiple objects unless the context clearly dictates otherwise.

As used herein, the term “set” refers to a collection of one or more objects. Thus, for example, a set of objects can include a single object or multiple objects.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to +10% of that numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%. For example, a first numerical value can be “substantially” or “about” the same as or equal to a second numerical value if the first numerical value is within a range of variation of less than or equal to +10% of the second numerical value, such as less than or equal to +5%, less than or equal to +4%, less than or equal to +3%, less than or equal to +2%, less than or equal to #1%, less than or equal to +0.5%, less than or equal to +0.1%, or less than or equal to +0.05%.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

As used herein, the term “nanostructure” refers to an object that has at least one dimension in a range of about 1 nm to about 1000 nm. A nanostructure can have any of a wide variety of shapes, and can be formed of a wide variety of materials. Examples of nanostructures include nanofibers, nanoplatelets, and nanoparticles.

As used herein, the term “nanoparticle” refers to a nanostructure that is generally or substantially spherical or spheroidal. Typically, each dimension of a nanoparticle is in a range of about 1 nm to about 1000 nm, and the nanoparticle has an aspect ratio of about 5 or less, such as about 3 or less, about 2 or less, or about 1.

As used herein, the term “nanofiber” refers to an elongated nanostructure. Typically, a nanofiber has a lateral dimension (e.g., a width) in a range of about 1 nm to about 1000 nm, a longitudinal dimension (e.g., a length) in a range of about 1 nm to about 1000 nm or greater than about 1000 nm, and an aspect ratio that is greater than about 5, such as about 10 or greater.

As used herein, the term “nanoplatelet” refers to a planar-like, nanostructure.

As used herein, the term “microstructure” refers to an object that has at least one dimension in a range of about 1 μm to about 1000 μm. A microstructure can have any of a wide variety of shapes, and can be formed of a wide variety of materials. Examples of microstructures include microfibers, microplatelets, and microparticles.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

1. A nanocomposite ceramic or glass material, comprising:
one or more matrix materials; and
one or more nanostructures dispersed with the matrix material;
wherein the one or more nanostructures comprises a core-shell nanostructure.

2. The nanocomposite ceramic or glass material of claim 1, wherein:
the core-shell nanostructure comprises a core material and a shell material coating the core nanostructure; and
the shell material improves the wettability of the nanostructure by the matrix material and dispersion of the nanostructure within the matrix, relative to the core nanostructure alone.

3. The nanocomposite ceramic or glass material of claim 1, wherein the shell material comprises the same material as the matrix material.

4. The nanocomposite ceramic or glass material of claim 1, wherein the core nanostructure comprises a carbon-based material.

5. The nanocomposite ceramic or glass material of claim 1, wherein the nanostructure is present in the matrix material at a concentration (v/v) of at least about 1.0%.

6. The nanocomposite ceramic or glass material of claim 1, wherein the nanostructure is present in the matrix material at a concentration (v/v) of at least about 10%.

7. The nanocomposite ceramic or glass material of claim 1, wherein the nanocomposite ceramic or glass material has a fracture toughness of 2 MPa·m¹² or greater.

8. The nanocomposite ceramic or glass material of claim 1, wherein the nanocomposite ceramic or glass material has a strain limit of about 2% or greater.

9. The nanocomposite ceramic or glass material of claim 1, wherein the nanocomposite ceramic or glass material has a strength of about E/50 or greater, wherein E is elastic modulus.

10. A method of forming a nanocomposite ceramic or glass material, comprising:
(a) mixing: (i) raw matrix powder(s), (ii) nanostructure powder(s), and optionally (iii) one or more viscosity-reducing materials;
(b) dispersing the raw matrix powder(s), nanostructure powder(s), and, optionally, the one or more viscosity-reducing materials in a solvent to form a nanostructure dispersion;
(c) agitating the nanostructure dispersion to form a slurry;
(d) drying the slurry to form a mixed powder;
(e) melting the mixed powder; and
(f) cooling the melted mixed powder to form the nanocomposite ceramic or glass material;
wherein the nanostructure powder(s) comprises a core-shell nanostructure.

11. The method of claim 10, wherein:
the core-shell nanostructure comprises a core material and a shell material coating the core nanostructure; and
the shell material improves the wettability of the nanostructure by the matrix material and/or dispersion of the nanostructure within the matrix, relative to the core nanostructure alone.

12. The method of claim 10, wherein the shell material comprises the same material as the matrix material.

13. The method of claim 10, wherein the core nanostructure comprises a carbon-based material.

14. The method of claim 10, wherein in the nanocomposite ceramic or glass material, the nanostructure is present in the matrix material at a concentration (v/v) of at least about 1%.

15. The method of claim 10, wherein the nanostructure is present in the matrix material at a concentration (v/v) of at least about 10%.

16. The method of claim 10, wherein the nanocomposite ceramic or glass material has a fracture toughness of 2 MPa m^{1/2} or greater.

17. The method of claim 10, wherein the nanocomposite ceramic or glass material has a strain limit of about 2% or greater.

18. The method of claim 10, wherein the nanocomposite ceramic or glass material has a strength of about E/50 or greater, wherein E is elastic modulus.
